(19) United States
(12) Patent Application Publication
(10) Pub. No.: US 2025/0032339 A1
(43) Pub. Date: Jan. 30, 2025

(54) WALKING ASSISTANCE DEVICE USING FABRIC

(71) Applicant: HUROTICS Inc., Seoul (KR)

(72) Inventors: Seungtae YANG, Suwon-si (KR); Kyeongmin LIM, Seoul (KR); Jaeha YANG, Seoul (KR)

(73) Assignee: HUROTICS Inc., Seoul (KR)

(21) Appl. No.: 18/777,909

(22) Filed: Jul. 19, 2024

(30) Foreign Application Priority Data
Jul. 25, 2023 (KR) 10-2023-0096581
Mar. 7, 2024 (KR) 10-2024-0032577

(51) Int. Cl. A61H 3/00

(52) U.S. Cl. CPC A61H 3/00; A61H 2201/0214; A61H 2201/1215; A61H 2201/165

(57) ABSTRACT

A walking assistance device utilizing a fabric according to various embodiments of the present invention is disclosed. The walking assistance device utilizing a fabric includes a driving part configured to generate a driving force and a force transmitting part including a fabric part, which is connected to the driving part, and configured to transmit a force to a part of a user's body by unwinding or rewinding due to the driving force applied from the driving part.

### CROSS-REFERENCE TO RELATED APPLICATION

This application claims priority to and the benefit of Korean Patent Application Nos. 10-2023-0096581 filed on Jul. 25, 2023 and 10-2024-0032577 filed on Mar. 7, 2024, the disclosure of which is incorporated herein by reference in its entirety.

### BACKGROUND

### 1. Field of the Invention

The present invention relates to a walking assistance device providing an auxiliary force when a user walks, and more particularly, to a walking assistance device providing an improved auxiliary force while minimizing a weight through design utilizing a fabric material.

### 2. Discussion of Related Art

A wearable robot (or traveling assistance device) is a device that is worn as clothing by a user and transmits an auxiliary force to the clothing through a driving part such as a motor to assist movement of the user. The wearable robot helps a user (an elderly person or a patient) who needs walking assistance or rehabilitation treatment to easily carry out everyday life or receive treatment, and due to being low-weight and low-volume as compared to the existing exoskeletal rehabilitation robots, the wearable robot can be handled and worn easily.

Korean Patent Registration No. 10-2421996 discloses a wearable robot to which highly functional clothing is applied. In the case of the conventional wearable robot, when the wearable robot provides an auxiliary force, there is concern that an injury may occur due to friction caused between the skin and the wearable robot itself or a means transmitting the force. Also, since the conventional wearable robot is manufactured to be heavy for an elderly person or a patient to use, there is concern that its usability in everyday life or treatment process may be limited.

Therefore, there may be demand for research and development on wearable robots that can be used safely and conveniently by users wearing the wearable robots.

### SUMMARY OF THE INVENTION

The present invention is directed to providing a walking assistance device providing an improved auxiliary force while minimizing a weight through design utilizing a fabric material.

The objects of the present invention are not limited to the above-mentioned object, and other unmentioned objects will be able to be clearly understood by those skilled in the art from the following description.

One embodiment of the present invention discloses a walking assistance device utilizing a fabric. The walking assistance device utilizing a fabric includes a driving part configured to generate a driving force and a force transmitting part including a fabric part, which is connected to the driving part, and configured to transmit a force to a part of a user's body by unwinding or rewinding due to the driving force applied from the driving part.

In an alternative embodiment, the driving part may include a driving housing, a driving pulley provided in the driving housing and configured to rotate and have the fabric part coupled thereto, a driving module configured to generate a driving force for rotating the driving pulley, a gear part configured to transmit the driving force generated by the driving module to the driving pulley, and a fan configured to release heat generated in the driving housing to the outside.

In an alternative embodiment, the driving housing may include an upper groove provided upward, a protective member formed at a predetermined separation distance from the upper groove, and a through-groove having the shape of a groove through which the fabric part passes.

In an alternative embodiment, the through-groove may include a guide part configured to guide the fabric part, and the guide part may include a contact surface provided to be able to come in contact with one side surface of the fabric part and an elastic body provided between the contact surface and the driving housing to provide an elastic force to the contact surface.

In an alternative embodiment, the driving pulley may include a driving main body having a cylindrical shape and two support members respectively provided at both ends of the driving main body, and the driving main body may have an insertion fixing groove into which a fixing pin is able to be inserted formed therein.

In an alternative embodiment, the fabric part may be provided to have a predetermined area using a fabric material, provided to be wound around the driving main body, and configured so that an area discharged to the outside of the driving part changes according to rotation of the driving main body.

In an alternative embodiment, the fabric part may be coupled to the fixing pin while fixed in a state in which at least some portions of the fabric part overlap each other with respect to the fixing pin, and the fabric part coupled to the fixing pin may be inserted into the insertion fixing groove and connected to the driving part.

In an alternative embodiment, the force transmitting part may include a lower end pulley provided to have a predetermined separation distance from the driving part, connected to the fabric part extending from the driving part, and configured to change a direction of provision of the fabric part, and a fixing part to which one end of the fabric part whose direction of provision has been changed by the lower end pulley is fixed.

In an alternative embodiment, the force transmitting part may include a moving pulley provided to have a predetermined separation distance from the driving part, connected to the fabric part extending from the driving part, and configured to change a direction of provision of the fabric part multiple times, a fixing pulley provided at the driving part and configured to change the direction of provision of the fabric part, whose direction of provision has been changed by the moving pulley, to a direction toward the moving pulley again, and a fixing part provided at the driving part and to which one end of the fabric part whose direction of provision has been changed by the moving pulley is fixed.

In an alternative embodiment, the moving pulley may include a first body configured to change a direction of provision of the fabric part discharged from the driving part to a direction toward the fixing pulley, a second body provided to have a predetermined separation distance from the first body and configured to change the direction of provision of the fabric part to a direction toward the fixing part, and a joining part configured to connect the first body and the second body.

In an alternative embodiment, the walking assistance device may further include a first support part fixed at a first region of the user's body and provided to be couplable to the driving part and a second support part fixed at a second region of the user's body and provided to be couplable to the force transmitting part.

Other details of the present invention are incorporated in the detailed description and the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates an exemplary schematic diagram of a walking assistance device utilizing a fabric according to one embodiment of the present invention;

FIG. 2 is an exemplary view illustrating an example of a user wearing the walking assistance device utilizing a fabric according to one embodiment of the present invention;

FIG. 3 is an exemplary view for describing a process in which the walking assistance device utilizing a fabric according to one embodiment of the present invention provides an auxiliary force for walking assistance;

FIG. 4 is an exemplary view for describing components of the walking assistance device utilizing a fabric according to one embodiment of the present invention;

FIGS. 5A to 5C are exemplary views for describing coupling between a driving pulley and a fabric part according to one embodiment of the present invention:

FIG. 6 is an exemplary view for describing a through-groove and a guide part according to one embodiment of the present invention:

FIG. 7 is an exemplary view illustrating an example of a force transmitting part according to one embodiment of the present invention:

FIG. 8 is an exemplary view illustrating an example of a force transmitting part according to another embodiment of the present invention; and

FIGS. 9A to 9C are exemplary views for describing a utilization example of the walking assistance device utilizing a fabric according to one embodiment of the present invention.

### DETAILED DESCRIPTION OF EXEMPLARY EMBODIMENTS

Various embodiments and/or aspects will be disclosed below with reference to the accompanying drawings. In the following description, for illustrative purposes, several specific details will be disclosed to assist an overall understanding of one or more aspects. However, those of ordinary skill in the art to which the present invention pertains should be aware of the fact that such aspect(s) may be executed even without such specific details. Specific illustrative aspects of one or more aspects will be described in detail with reference to the accompanying drawings in the following description. However, such aspects are illustrative, some of various methods in principles of various aspects may be used, and the following description is intended to incorporate all of such aspects and their equivalents. Specifically, the term “embodiment,” “example,” “aspect,” or the like used herein may not be interpreted as indicating that an arbitrary aspect or design is more favorable or advantageous than other aspects or designs.

Hereinafter, regardless of the drawings symbols, same or similar components will be denoted by the same reference numerals, and overlapping description thereof will be omitted. Also, in describing embodiments disclosed herein, when detailed description of a known related art is determined as having the possibility of obscuring the gist of the embodiments disclosed herein, the detailed description thereof will be omitted. Also, the accompanying drawings are only for facilitating the understanding of the embodiments disclosed herein, and the technical spirit disclosed herein is not limited by the accompanying drawings.

Although terms such as first and second are used to describe various elements or components, of course, these elements or components are not limited by these terms. These terms are only used to distinguish one element or component from another element or component. Therefore, of course, a first element or component mentioned below may also be a second element or component within the technical spirit of the present invention.

Unless defined otherwise, all terms including technical and scientific terms used herein may be used as meanings that may be commonly understood by those of ordinary skill in the art to which the present invention pertains. Also, terms defined in commonly used dictionaries should not be interpreted in an idealized or overly formal sense unless expressly so defined herein.

In addition, the term “or” is intended to mean inclusive “or” instead of exclusive “or.” That is, unless specified otherwise or the context clearly indicates otherwise, “X uses A or B” is intended to mean one of natural inclusive substitutions. That is, when X uses A, X uses B, or X uses both A and B, “X uses A or B” may apply to either of these cases. Also, the term “and/or” used herein should be understood as referring to and including all possible combinations of one or more of the listed related items.

Also, the terms “include” and/or “including” should be understood as indicating the presence of corresponding features and/or components but not excluding the presence or addition of one or more other features, components, and/or groups thereof. Also, unless specified otherwise or the context clearly indicates singularity, a singular expression should be generally interpreted as indicating “one or more” in the present specification and the claims.

When a certain component is mentioned as being “connected” or “linked” to another component, it should be understood that the component may be directly connected or linked to the other component, but another component may be present therebetween. On the other hand, when a certain component is mentioned as being “directly connected” or “directly linked” to another component, it should be understood that another component is not present between the two components.

When a component or layer is referred to as being “on” another component or layer, this not only includes a case in which the component or layer is right above the other component or layer but also includes a case in which another layer or component is interposed therebetween. On the other hand, when a component is referred to as being “directly on” or “right above” another component, this indicates that another component or layer is not interposed therebetween.

Spatially relative terms such as “below,” “beneath,” “lower,” “above,” and “upper” may be used to easily describe the relationship between one component and other components illustrated in the drawings. Spatially relative positions should be understood as encompassing different directions of a device that is in use or operating, in addition to directions depicted in the drawings.

Objects and effects of the present invention and technical configurations for achieving the same will become apparent with reference to embodiments described in detail below and the accompanying drawings. In describing the present invention, when detailed description of known functions or configurations is determined as having the possibility of unnecessarily obscuring the gist of the present invention, the detailed description thereof will be omitted. Also, the terms described below are terms defined in consideration of their functionality in the present invention and may vary depending on an intention of a user or an operator, customary practice, or the like.

However, the present invention is not limited by embodiments disclosed below and may be implemented in various different forms. The present embodiments are provided to make the disclosure of the present invention complete and to fully inform those of ordinary skill in the art to which the present invention pertains of the scope of the disclosure, and the present invention is only defined by the scope of the claims. Therefore, the definition should be made based on the entire content of the present specification.

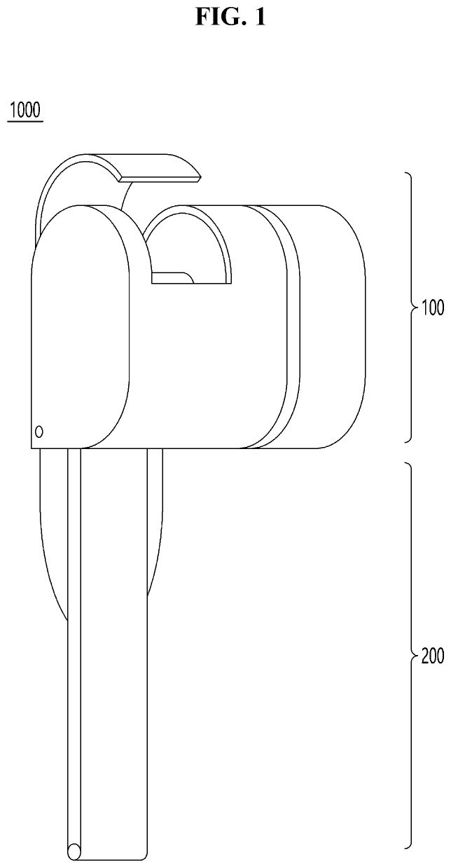

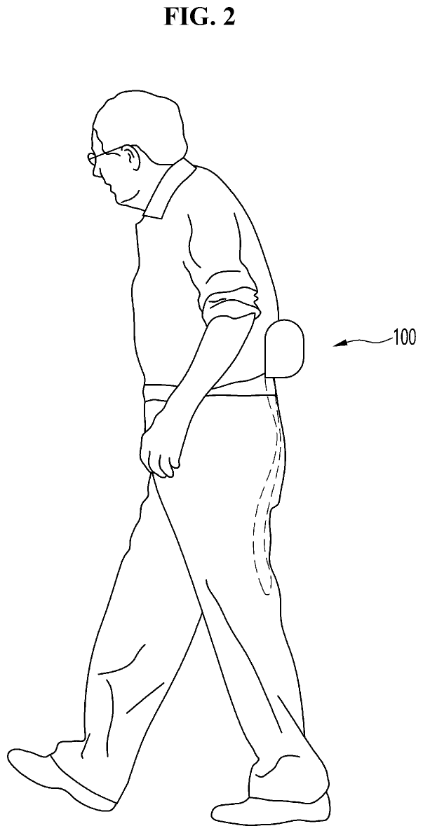

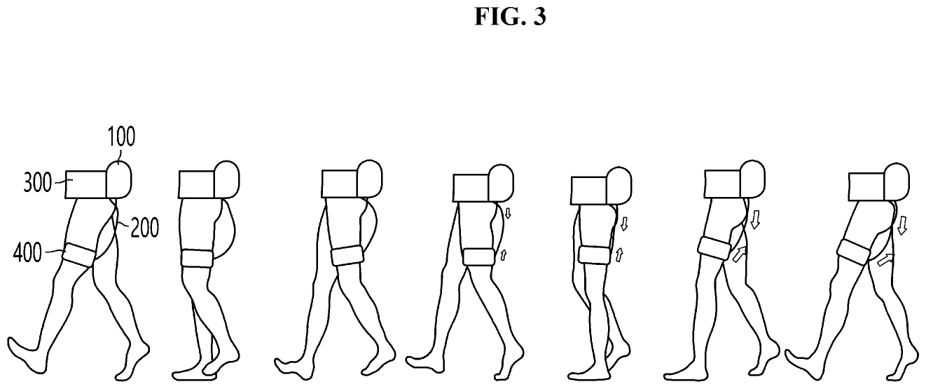

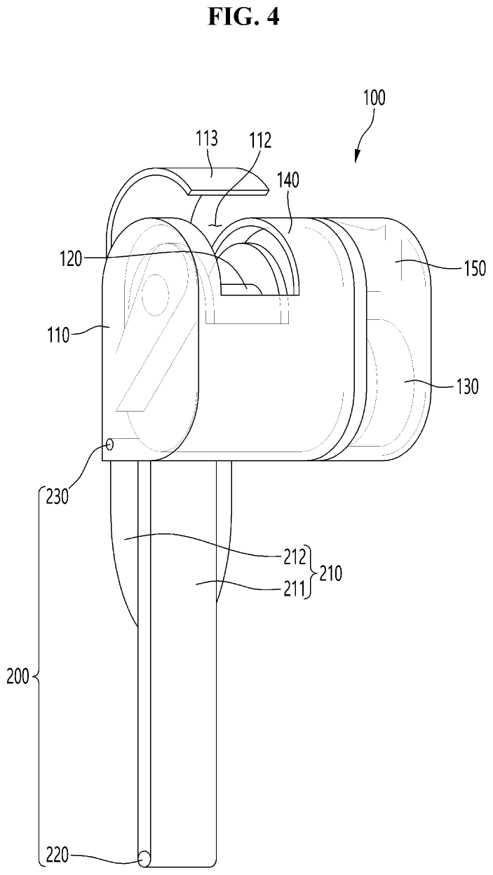

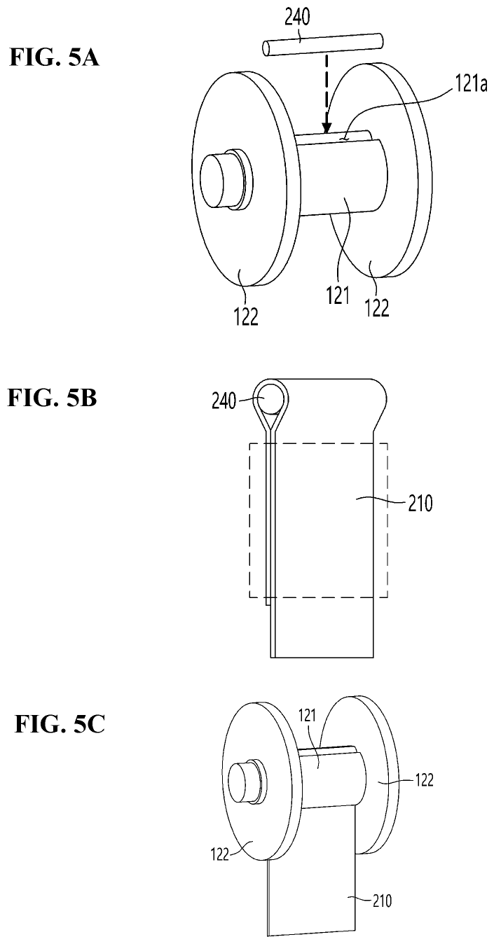

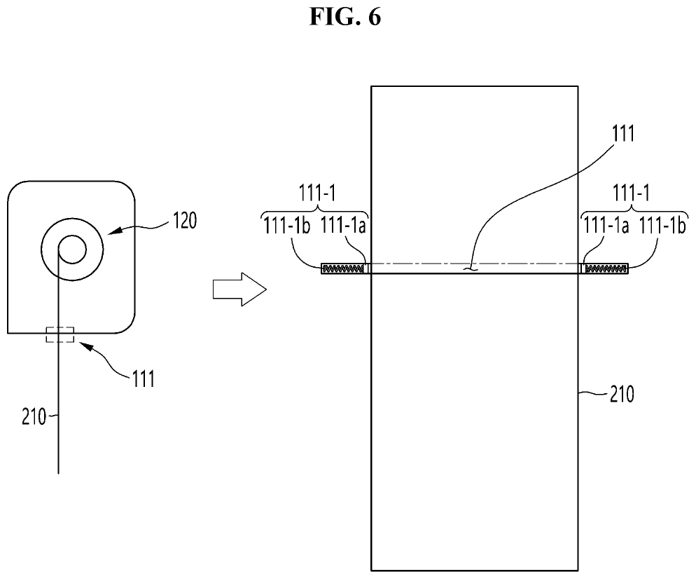

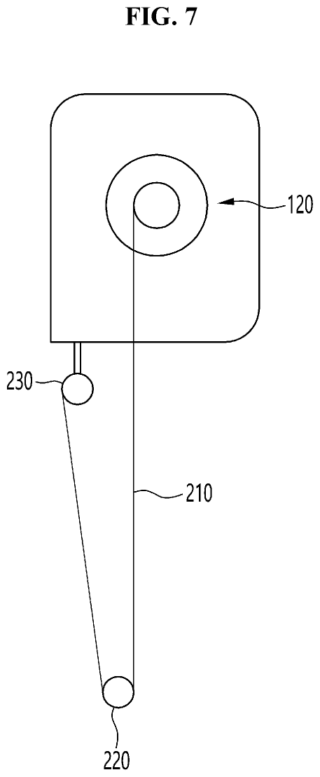

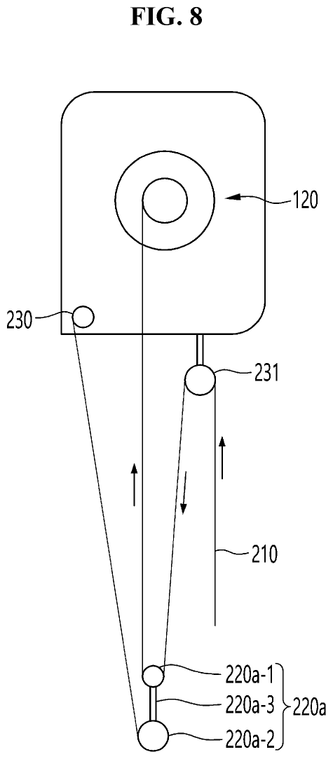

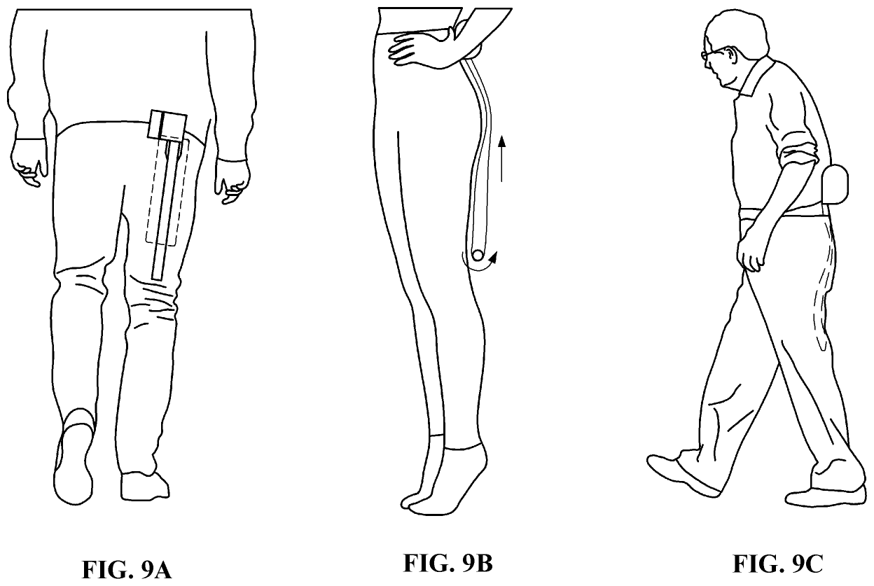

FIG. 1 illustrates an exemplary schematic diagram of a walking assistance device utilizing a fabric according to one embodiment of the present invention. FIG. 2 is an exemplary view illustrating an example of a user wearing the walking assistance device utilizing a fabric according to one embodiment of the present invention. FIG. 3 is an exemplary view for describing a process in which the walking assistance device utilizing a fabric according to one embodiment of the present invention provides an auxiliary force for walking assistance. FIG. 4 is an exemplary view for describing components of the walking assistance device utilizing a fabric according to one embodiment of the present invention. FIGS. 5A to 5C are exemplary views for describing coupling between a driving pulley and a fabric part according to one embodiment of the present invention. FIG. 6 is an exemplary view for describing a through-groove and a guide part according to one embodiment of the present invention. FIG. 7 is an exemplary view illustrating an example of a force transmitting part according to one embodiment of the present invention. FIG. 8 is an exemplary view illustrating an example of a force transmitting part according to another embodiment of the present invention. FIGS. 9A to 9C are exemplary views for describing a utilization example of the walking assistance device utilizing a fabric according to one embodiment of the present invention.

According to one embodiment of the present invention, a walking assistance device 1000 utilizing a fabric may provide an auxiliary force to a user. The walking assistance device 1000 utilizing a fabric is a configuration that provides an auxiliary force necessary for movement, such as walking, while worn by the user. To this end, the walking assistance device 1000 utilizing a fabric may include one or more members (for example, a first support part or a second support part) wearable on the body and a driving part 100 driven while connected to the corresponding members through a fabric part 210 and configured to impart a force by causing the fabric part 210 to unwind or rewind.

In the present invention, the fabric part 210 may be provided using a fabric material and may provide an auxiliary force when the user walks. The fabric may be a fiber product such as a woven fabric, a knitted fabric, or a nonwoven fabric. Since the fabric has a degree of freedom and stiffness and is made of a fibrous material, there is an advantage in that rubbing can be prevented even when the fabric is in contact with the user's skin. Also, when the fabric is utilized, there is an advantage in that replacement thereof is easy. In a specific embodiment, the fabric part 210 may be provided using a nonwoven fabric or woven material having high wear resistance, a high stiffness, a small thickness, and a low friction coefficient. By utilizing the fabric, the walking assistance device 1000 utilizing a fabric according to the present invention can provide a comfortable feeling of use by protecting the user's skin, provide an appropriate auxiliary force when the user walks through high wear resistance and stiffness, and provide convenience through easy replacement.

As illustrated in FIG. 1, the walking assistance device 1000 utilizing a fabric may include the driving part 100 and a force transmitting part 200. The components illustrated in FIG. 1 are illustrative, and additional components may be present, or some of the components illustrated in FIG. 1 may be omitted.

In a specific embodiment, the walking assistance device 1000 utilizing a fabric may include the driving part 100 configured to generate a driving force and the force transmitting part 200 including the fabric part 210, which is connected to the driving part 100, and configured to transmit a force to a part of the user's body by unwinding or rewinding due to the driving force applied from the driving part 100.

In more detail, referring to FIGS. 2 and 3, the driving part 100 generating the driving force may be provided to be fixed at a first region of the user's body. For example, a first support part 300 may be fixed at the first region of the user's body and provided to be couplable to the driving part 100. The first support part 300 may be provided to be wearable on one position of the user's body. Here, the first region of the user's body may be a region relating to the waist. For example, the first support part 300 may include a coupling mechanism that can be fixed to a belt, and in this way, may be fixed at one position of the user's body. That is, the user may wear the first support part 300, place the first support part 300 at his or her waist region, and couple the driving part 100 to the corresponding first support part 300. Accordingly, the driving part 100 may be located to be fixed at the first region (for example, the waist region) of the user's body.

Also, the force transmitting part 200 provided to be connected to the driving part 100 and providing an auxiliary force for walking of the user according to being unwound or rewound due to the driving part 100 may be provided to be fixed at a second region of the user's body. For example, a second support part 400 may be fixed at the second region of the user's body and provided to be couplable to the force transmitting part 200. The second support part 400 may be provided to be wearable on one position of the user's body. Here, the second region of the user's body may be a region located relatively lower than the first region of the user's body and may be a region relating to the knee. That is, the user may wear the second support part 400, place the second support part 400 at his or her knee region, and connect one end of the force transmitting part 200 (for example, one region of the fabric part) to the corresponding second support part 400.

As the fabric part 210 unwinds and rewinds due to the driving part 100 fixed at the first region, a force may be transmitted to a leg region (for example, the knee region) of the user. That is, in a process in which the user walks, a force is transmitted to the user's leg as the fabric part 210 unwinds or rewinds due to the driving force generated by the driving part 100, and in this way, the user receives an auxiliary force for walking. Although the first region and the second region of the user's body have been described above as being the waist region and the knee region, respectively, the first region and the second region may relate to other regions of the user's body. For example, the first region may be a thigh region, and the second region may be an ankle region or calf region located relatively lower than the thigh.

According to one embodiment of the present invention, the driving part 100 serves to generate the driving force and cause the fabric part 210 to unwind and rewind. As illustrated in FIG. 4, the driving part 100 of the walking assistance device 1000 utilizing a fabric may include a driving housing 110, a driving pulley 120, a driving module 130, a gear part 140, and a fan 150.

In an embodiment, the driving part 100 may include the driving housing 110 forming an inner space in which components of the driving part 100 are provided. The driving housing 110 forms an exterior of the driving part 100. An attachment/detachment mechanism for fixing and coupling to the first support part 300 may be provided on an outer side of the driving housing 110. The attachment/detachment mechanism may be a configuration for fixing the driving housing 110 at one position of the first support part 300 and separating the driving housing 110. The attachment/detachment mechanism may easily fix the driving part 100 at one position of the first support part 300 or separate the driving part 100 using at least one of, for example, a clip attachment/detachment method, a magnet attachment/detachment method, a band attachment/detachment method, and an adsorption/desorption method. The detailed description of the attachment/detachment mechanism given above is only an example, and the present invention may include various other forms of attachment/detachment methods that can easily fix the driving part at one position of the first support part.

According to one embodiment, the driving housing 110 may include an upper groove 112 provided upward, a protective member 113 formed at a predetermined separation distance from the upper groove 112, and a through-groove 111 having the shape of a groove through which the fabric part 210 passes.

In an embodiment, the driving housing 110 may include the upper groove 112 having the shape of an open groove. The upper groove 112 serves as a passage for insertion of the driving pulley 120. The driving pulley 120 may be inserted into the driving housing 110 or taken out of the driving housing 110 through the upper groove 112 formed at one region of the driving housing 110. With such a configuration of the upper groove, the driving pulley 120 can be easily detached from the driving housing 110, and thus there is an advantage in that the fabric part 210 can be easily replaced. For example, the fabric part 210 may be worn out according to continuous utilization of the device, and in this case, replacement of the worn-out fabric part 210 may be necessary. The upper groove 112 may be formed upward in the driving housing 110 for easy insertion of the driving pulley 120. The user may take out the driving pulley 120 through the upper groove formed in the driving housing 110, replace the fabric part coupled to the driving pulley 120 with a new fabric part and couple the new fabric part, and then bond the driving pulley 120 to the inside of the driving housing 110 again. In this way, with the configuration of the upper groove 112, the driving pulley 120 can be easily inserted into or separated from the inner space of the driving housing 110, and thus there is an advantage in that convenience for the user is improved due to further facilitating the replacement of the fabric part.

As illustrated in FIG. 4, the protective member 113 is a configuration provided upward from the upper groove 112 to prevent introduction of foreign matter into the upper groove 112. With the configuration of the protective member 113, introduction of foreign matter into the driving housing 110 can be minimized. For example, when the protective member 113 is not provided, since the upper groove 112 is exposed to the outside, foreign matter (for example, clothing or the user's body) may be introduced into the driving housing 110 through the open groove at the corresponding region, and a failure of the device may occur. Meanwhile, in the case of the walking assistance device 1000 utilizing a fabric according to the present invention, since the protective member 113 is configured upward from the upper groove 112 to protect the upper groove 112, a failure of the device due to introduction of foreign matter can be prevented.

According to an embodiment, the driving housing 110 may include the through-groove 111 having the shape of a groove through which the fabric part 210 passes. The through-groove 111 may be provided to have the shape of a downward groove in the driving housing 110 and may allow the fabric part 210 to pass therethrough. That is, the fabric part 210 may be provided to pass through the through-groove 111 and may be discharged to the outside of the driving housing 110. In an embodiment, one end of the fabric part 210 may be coupled to one region inside the driving housing 110 while fixed to the driving pulley 120 and may unwind or rewind according to the rotation of the driving pulley 120. For example, as the driving pulley 120 rotates in one direction due to control of the driving module 130, the fabric part 210 provided to be wound around the driving pulley 120 may unwind, and accordingly, an area of the fabric part discharged to the outside increases. Conversely, as the driving pulley 120 rotates in the other direction due to control of the driving module 130, the fabric part 210 may rewind around the driving pulley 120.

In one embodiment, the through-groove 111 may include a guide part 111-1 configured to guide the fabric part 210. The guide part 111-1 is a configuration guiding the fabric part 210 at both side surfaces of the fabric part 210 provided to pass through the through-groove 111.

More specifically, as illustrated in FIG. 6, the guide part 111-1 may include a contact surface 111-1a provided to be able to come in contact with one side surface of the fabric part 210 and an elastic body 111-1b provided between the contact surface 111-1a and the driving housing 110 to provide an elastic force to the contact surface 111-1a.

For example, when the guide part 111-1 is not provided, a partial region of the fabric part 210 may be folded or twisted in a continuous utilization process of the device (that is, a process in which the fabric part unwinds or rewinds), or one region of the fabric part 210 may be damaged (for example, torn) due to wear caused by rubbing against both sidewalls of the through-groove 111. As a result, the through-groove 111 is twisted or folded or blocked by the torn fabric part 210, and an appropriate auxiliary force cannot be provided to the user. The guide part 111-1 is a configuration for preventing the fabric part 210 from being caught in the space of the through-groove 111 while passing through the through-groove 111 (that is, a catching prevention configuration) and serves to flexibly guide the fabric part 210 moving through the through-groove 111.

Since the guide part 111-1 is provided to come in contact with both side surfaces of the fabric part 210, flexible movement of the fabric part 210 at a predetermined distance may be supported through the configuration of the elastic body, and a force applied to the fabric part 210 itself can be minimized. That is, since the force transmitted to the fabric part 210 itself is minimized, the corresponding fabric part 210 can be prevented from being twisted, folded, or damaged. That is, the guide part 111-1 may come in contact with the fabric part 210 through the contact surfaces 111-1a at both side surfaces of the fabric part 210 provided to pass through the through-groove 111 and may allow the fabric part 210 to move more flexibly based on an elastic force utilizing the elastic body.

Also, in an embodiment, the driving part 100 may include the driving module 130 configured to generate a driving force for rotating the driving pulley 120 and may include the gear part 140 configured to transmit the driving force generated by the driving module 130 to the driving pulley 120.

The driving module 130 is a device that converts electrical energy into mechanical energy using a force received by a conductor, in which current flows, in a magnetic field, and the driving module 130 may allow rotation of the gear part 140 through the generated mechanical energy. Referring to FIG. 4, the gear part 140 may be coupled and connected to the driving module 130 and may rotate the driving pulley 120 using the driving force (that is, mechanical energy) generated by the driving module 130. That is, the gear part 140 is located between the driving pulley 120 and the driving module 130 and serves to transmit the driving force generated by the driving module 130 to the driving pulley 120, and the driving pulley 120 may rotate through the configuration of the gear part 140. In various embodiments, the driving module 130 may provide an appropriate auxiliary force to the user by allowing the driving pulley 120 to rotate in one direction (for example, clockwise) or the other direction (for example, counterclockwise) according to various walking situations of the user. For example, the driving module 130 may provide an auxiliary force to the user by determining a walking state of the user through at least one of the number of rotations, the rotating direction, and the rotating speed of the driving pulley 120 and controlling the driving pulley 120 based on the determined walking state of the user so that the fabric part 210 unwinds or rewinds.

Also, in an embodiment, the driving part 100 may include the fan 150 configured to release heat generated in the driving housing 110 to the outside. The fan 150 may discharge air in the driving housing 110 to the outside. Heat is generated in the driving housing 110 according to driving of the driving module 130, and when the generated heat is not released, the driving module 130 is overheated, and a failure occurs. The fan 150 may discharge the internal air to the outside to prevent overheating of the driving module 130 and prevent a failure.

In an embodiment, the driving part 100 may include the driving pulley 120 provided in the driving housing 110 and configured to rotate and have the fabric part 210 coupled thereto. The driving pulley 120 is coupled to the fabric part 210 and serves to allow the fabric part 210 to unwind and rewind by rotating. That is, the fabric part 210 of the present invention provides an auxiliary force to the user according to being wound around or unwound from the driving pulley 120.

The fabric part 210 is provided to have a predetermined area using a fabric material, provided to be wound around a driving main body 121, and configured so that an area discharged to the outside of the driving part changes according to the rotation of the driving main body 121. The fabric part 210 may be configured to have high durability by being made of a nonwoven fabric or woven material. Also, the fabric part may be made of a material having high wear resistance, a high stiffness, a small thickness, and a low friction coefficient.

In various embodiments of the present invention, the fabric part 210 may be folded in half (that is, configured in two layers) to increase stiffness, fabric parts 210 made of different materials may be connected in series or parallel, or an elastic body may be connected to an end of the fabric part 210 for use of the fabric part 210. Also, in the present invention, a fabric whose front and back sides are made of different materials may be used to prevent an injury to the user's skin or damage to the clothing.

More specifically, the driving pulley 120 may include the driving main body 121 having a cylindrical shape and two support members 122 respectively provided at both ends of the driving main body. Referring to FIG. 5A, the two support members 122 may be provided to be respectively connected to both ends of the driving main body 121.

In an embodiment, the driving main body 121 may have an insertion fixing groove 121a into which a fixing pin 240 is able to be inserted formed therein. As illustrated in FIG. 5A, the insertion fixing groove 121a may be formed in one region of the driving main body 121, and the fixing pin 240 may be fixed and coupled through the corresponding insertion fixing groove 121a.

Specifically, as illustrated in FIG. 5B, the fabric part 210 may be coupled to the fixing pin 240 while fixed in a state in which at least some portions of the fabric part 210 overlap each other with respect to the fixing pin 240. In this case, the fabric part 210 is provided to be coupled to the fixing pin 240 by being fixed using at least one method of sewing, adhering, and surface pressing in the state in which some portions of the fabric part 210 overlap each other. Also, as illustrated in FIG. 5C, the fabric part 210 may be connected to the driving part 100, that is, the driving pulley 120, by being inserted into the insertion fixing groove 121a in the state in which the fabric part 210 is coupled to the fixing pin 240.

As described above, the fabric part 210 is fitted and coupled to the insertion fixing groove 121a formed in the driving pulley 120 in the state in which the fabric part 210 and the fixing pin 240 are coupled, and due to the rotation of the driving pulley 120, the fabric part 210 is wound around the corresponding driving pulley. For example, the fabric part 210 may be worn out according to continuous utilization of the device, and replacement of the fabric part 210 may be necessary. In this case, the fabric part 210 wound around the driving pulley 120 may be easily replaced through the configurations of the insertion fixing groove 121a and the fixing pin 240. That is, the worn-out fabric part 210 may be easily replaced by separating the fixing pin 240 from the insertion fixing groove 121a, removing the existing fabric part, coupling a new fabric part to the fixing pin, and then coupling the fixing pin 240 to the insertion fixing groove 121a again.

In various embodiments, direct friction may occur between the skin and the clothing when an auxiliary force is provided by utilizing a rope, a cable, or the like. Since an injury to the skin or damage to the clothing may occur as a result, there is a problem in that a limit exists in clothing that may be worn.

Meanwhile, according to the present invention, by providing an auxiliary force by folding a fabric, it is possible to prevent an injury to the skin or damage to the clothing. The walking assistance device 1000 utilizing a fabric according to the present invention can protect the skin and clothing through movement of portions of the fabric relative to each other and can address a limit in clothing that may be worn. In this way, the walking assistance device 1000 utilizing a fabric according to the present invention can be worn in clothing and utilized to prevent the device from being exposed to the outside.

According to one embodiment of the present invention, the force transmitting part 200 may include a lower end pulley 220 and a fixing part 230. The fabric part 210 is discharged to the outside of the driving housing 110 through the through-groove 111 in a state in which the fabric part 210 is connected to one region of the driving part 100, that is, the driving pulley 120, and the fabric part 210 is provided to be connected to the fixing part 230 after coming in contact with the lower end pulley 220.

In more detail, referring to FIG. 7, the force transmitting part 200 may include the lower end pulley 220 provided to have a predetermined separation distance from the driving part 100, connected to the fabric part 210 extending from the driving part 100, and configured to change a direction of provision of the fabric part 210. The lower end pulley 220 serves to change an advancing direction of the fabric part 210.

Also, the force transmitting part 200 may include the fixing part 230 to which one end of the fabric part 210 whose direction of provision has been changed by the lower end pulley 220 is fixed. The fixing part 230 may be provided at one region outside the driving housing 110 and serves to fix one end of the fabric part 210. For example, in a state in which one end of the fabric part 210 is connected to the driving pulley 120, the other end of the fabric part 210 is connected to the fixing part 230, and the lower end pulley 220 configured to change the direction of provision of the fabric part 210 is disposed in a region between the one end and the other end.

That is, the fabric part 210 connected to the driving pulley 120 is provided in a form that surrounds the lower end pulley 220 provided toward a lower end of the driving pulley 120, and the fabric part 210 is connected to the fixing part 230 located above the corresponding lower end pulley 220 to form a folding structure. In this case, the second support part 400 may be connected to correspond to the region in which the lower end pulley 220 is provided, and an auxiliary force may be transmitted to one region (for example, the second region) of the user's body according to unwinding or rewinding of the fabric part 210.

In an additional embodiment, the fabric part 210 of the walking assistance device 1000 utilizing a fabric according to the present invention may be configured in a multi-layer folding method. For example, the force transmitting part 200 of the walking assistance device 1000 utilizing a fabric may be configured to include a moving pulley 220a. Here, the moving pulley 220a may be configured to wind the fabric part multiple times (for example, two times) and may additionally secure a gear ratio. In this case, a power transmission device such as a gear may not be needed for the driving part 100. Also, since a force that one fabric should withstand is significantly reduced, it is possible to utilize a fabric part that is thinner and has a narrow width. Also, by folding the fabric part 210 two times or more and securing a gear ratio, a required rotational force can be reduced, and the size with which the driving module is provided can be minimized. Further details of the multi-layer folding method will be given below with reference to FIG. 8.

According to another embodiment of the present invention, the force transmitting part 200 may include the moving pulley 220a provided to have a predetermined separation distance from the driving part 100, connected to the fabric part 210 extending from the driving part, and configured to change a direction of provision of the fabric part 210 multiple times.

Referring to FIG. 8, the moving pulley 220a may include a first body 220a-1 configured to change a direction of provision of the fabric part 210 discharged from the driving part 100 to a direction toward a fixing pulley 231. Also, the moving pulley 220a may include a second body 220a-2 provided to have a predetermined separation distance from the first body 220a-1 and configured to change the direction of provision of the fabric part 210 to a direction toward the fixing part 230. Also, the moving pulley 220a may include a joining part 220a-3 configured to connect the first body 220a-1 and the second body 220a-2. That is, the moving pulley 220a is a configuration in which the first body 220a-1 and the second body 220a-2 are connected through the joining part 220a-3 while remaining a predetermined distance apart from each other.

In an embodiment, the force transmitting part 200 may include the fixing pulley 231 provided at the driving part 100 and configured to change the direction of provision of the fabric part 210, whose direction of provision has been changed by the moving pulley 220a, to a direction toward the moving pulley 220a again.

Also, the force transmitting part 200 may include the fixing part 230 provided at the driving part 100 and to which one end of the fabric part 210 whose direction of provision has been changed by the moving pulley 220a is fixed. The fixing part 230 may be provided at one region outside the driving housing 110 and serves to fix one end of the fabric part 210. For example, in a state in which one end of the fabric part 210 is connected to the driving pulley 120, the other end of the fabric part 210 is connected to the fixing part 230, and the moving pulley 220a configured to change the direction of provision of the fabric part 210 multiple times is disposed in a region between the one end and the other end.

That is, the fabric part 210 extending from the driving part 100 is connected to surround the first body 220a-1 of the moving pulley 220a, and the direction of provision of the fabric part 210 is primarily changed to an upward direction. In this case, the fabric part 210 is connected to surround the fixing pulley 231, and the direction of provision of the fabric part 210 is changed to a downward direction again. The fabric part 210 that has passed the fixing pulley 231 is connected to surround the second body 220a-2 of the moving pulley 220a, the direction of provision of the fabric part 210 is changed to the upward direction again, and the fabric part 210 may be fixed to the fixing part 230.

As described above, by employing a movable pulley method utilizing the moving pulley 220a, the walking assistance device 1000 utilizing a fabric can secure a double gear ratio. That is, the walking assistance device 1000 utilizing a fabric can reduce a load applied to the fabric part by half. In this case, there is an advantage in that the fabric part 210 can be utilized to provide a driving force for thicknesses difficult to handle using the existing small motor (that is, driving module).

In short, by providing a walking assistance device whose weight is minimized by utilizing a fabric material, the walking assistance device 1000 utilizing a fabric according to the present invention can reduce burden on the user wearing the walking assistance device 1000. That is, the walking assistance device 1000 utilizing a fabric can be conveniently used by the user and provide a comfortable fit to the user. For example, referring to FIGS. 9A to 9C, the walking assistance device 1000 utilizing a fabric according to the present invention can be worn outside the clothing or worn in a hidden form inside the clothing (that is, pants), and scratches to the skin and clothing can be minimized by the fabric material.

Also, since a portion coming in contact with the user's skin is provided using a wide fabric surface, there is an advantage in that an injury caused by friction with the skin can be prevented. For example, referring to FIG. 9B, since the walking assistance device 1000 utilizing a fabric according to the present invention is provided using a fabric surface having a predetermined area, an injury caused by friction with the skin, such as pinching of the skin, can be minimized.

In addition, through design in which a fabric having a relatively wide area is folded multiple times, the magnitude of a driving force generated due to implementing the walking assistance device can be minimized, and accordingly, since the size of a driver is minimized, the weight and size of the device can be minimized.

The present invention provides a walking assistance device whose weight is minimized by utilizing a fabric material. In this way, burden on the user wearing the walking assistance device can be reduced. That is, the walking assistance device can be conveniently used by the user and provide a comfortable fit to the user.

Also, since a portion coming in contact with the user's skin is provided using a wide fabric surface, there is an advantage in that an injury caused by friction with the skin can be prevented.

In addition, through design in which a fabric having a relatively wide area is folded multiple times, the magnitude of a driving force generated due to implementing the walking assistance device can be minimized, and accordingly, since the size of a driver is minimized, the weight and size of the device can be minimized.

The effects of the present invention are not limited to the above-mentioned effects, and other unmentioned effects should be clearly understood by those skilled in the art from the above description.

Although embodiments of the present invention have been described above with reference to the accompanying drawings, those of ordinary skill in the art to which the present invention pertains should understand that the present invention may be carried out in other specific forms without changing the technical spirit or essential features thereof. Therefore, the embodiments described above should be understood as illustrative, instead of limiting, in all aspects.

What is claimed is:

1. A walking assistance device utilizing a fabric, the walking assistance device comprising:
a driving part configured to generate a driving force; and
a force transmitting part including a fabric part, which is connected to the driving part, and configured to transmit a force to a part of a user's body by unwinding or rewinding due to the driving force applied from the driving part.

2. The walking assistance device of claim 1, wherein the driving part includes:
a driving housing;
a driving pulley provided in the driving housing and configured to rotate and have the fabric part coupled thereto;
a driving module configured to generate a driving force for rotating the driving pulley;
a gear part configured to transmit the driving force generated by the driving module to the driving pulley; and
a fan configured to release heat generated in the driving housing to the outside.

3. The walking assistance device of claim 2, wherein the driving housing includes:
an upper groove provided upward;
a protective member formed at a predetermined separation distance from the upper groove; and
a through-groove having the shape of a groove through which the fabric part passes.

4. The walking assistance device of claim 3, wherein:
the through-groove includes a guide part configured to guide the fabric part; and
the guide part includes a contact surface provided to be able to come in contact with one side surface of the fabric part and an elastic body provided between the contact surface and the driving housing to provide an elastic force to the contact surface.

5. The walking assistance device of claim 2, wherein:
the driving pulley includes a driving main body having a cylindrical shape and two support members respectively provided at both ends of the driving main body; and
the driving main body has an insertion fixing groove into which a fixing pin is able to be inserted formed therein.

6. The walking assistance device of claim 5, wherein the fabric part is provided to have a predetermined area using a fabric material, provided to be wound around the driving main body, and configured so that an area discharged to the outside of the driving part changes according to rotation of the driving main body.

7. The walking assistance device of claim 6, wherein the fabric part is coupled to the fixing pin while fixed in a state in which at least some portions of the fabric part overlap each other with respect to the fixing pin, and the fabric part coupled to the fixing pin is inserted into the insertion fixing groove and connected to the driving part.

8. The walking assistance device of claim 5, wherein the force transmitting part includes:
a lower end pulley provided to have a predetermined separation distance from the driving part, connected to the fabric part extending from the driving part, and configured to change a direction of provision of the fabric part; and
a fixing part to which one end of the fabric part whose direction of provision has been changed by the lower end pulley is fixed.

9. The walking assistance device of claim 5, wherein the force transmitting part includes:
a moving pulley provided to have a predetermined separation distance from the driving part, connected to the fabric part extending from the driving part, and configured to change a direction of provision of the fabric part multiple times;
a fixing pulley provided at the driving part and configured to change the direction of provision of the fabric part, whose direction of provision has been changed by the moving pulley, to a direction toward the moving pulley again; and
a fixing part provided at the driving part and to which one end of the fabric part whose direction of provision has been changed by the moving pulley is fixed.

10. The walking assistance device of claim 9, wherein the moving pulley includes:
a first body configured to change a direction of provision of the fabric part discharged from the driving part to a direction toward the fixing pulley;
a second body provided to have a predetermined separation distance from the first body and configured to change the direction of provision of the fabric part to a direction toward the fixing part; and
a joining part configured to connect the first body and the second body.

11. The walking assistance device of claim 1, further comprising:
a first support part fixed at a first region of the user's body and provided to be couplable to the driving part; and
a second support part fixed at a second region of the user's body and provided to be couplable to the force transmitting part.
